(19) United States
(12) Patent Application Publication
(10) Pub. No.: US 2025/0325848 A1
(43) Pub. Date: Oct. 23, 2025

(54) RESPIRATORY EXTRACTION HOOD

(71) Applicant: Yu-Mei KUO, Tainan City (TW)

(72) Inventors: Yu-Mei KUO, Tainan City (TW); Sheng-Hsiu HUANG, Taoyuan City (TW); Chih-Wei LIN, New Taipei City (TW); Chih-Chieh CHEN, New Taipei City (TW)

(73) Assignee: Yu-Mei KUO, Tainan City (TW)

(21) Appl. No.: 18/750,210

(22) Filed: Jun. 21, 2024

(30) Foreign Application Priority Data
Apr. 17, 2024 (TW) 113114365

(51) Int. Cl. A62B 18/00; A62B 18/08; A62B 23/02

(52) U.S. Cl. CPC A62B 18/003; A62B 18/084; A62B 23/02

(57) ABSTRACT

A respiratory extraction hood includes a blocking member, an inner shell, an outer cover, wearing member, a suction assembly, a filter and a power supply. A collection space is defined between the blocking member and a user's face and communicable with a first and a second opening on the inner shell. The outer cover is detachably connected to the inner shell to define a pre-storing passage between it and the inner shell. The suction assembly drives a fan to suck in external air, which flows through an air inlet into the pre-storing passage that extends a distance between the user's nose and the air inlet. When the user exhales an amount of high-pressure air, a part of the high-pressure exhaled air flows initially into the pre-storing passage but is then sucked by the suction system to flow through the second opening and the filter without flowing out via the air inlet.

### FIELD OF THE INVENTION

The present invention relates to a respiratory extraction hood for covering a user's mouth and nose, and more particularly, to a respiratory extraction hood that includes a pre-storing passage to increase the distance between an air inlet and a collection space.

### BACKGROUND OF THE INVENTION

Masks are designed to cover a user's mouth and nose and to remove most hazardous substances, such as suspended particles and dust in the air, so as to stop viruses and bacteria in the air from entering the user's mouth and nose.

A respirator mask with filter is one type of mask. The respirator mask includes a filter canister or a filtering device to filter the air inhaled by the wearer in order to prevent hazardous substances in the air from directly flowing into the wearer's mouth and nose. However, the air exhaled by the wearer and containing virus or bacteria is not filtered to be directly emitted into surrounding air to contaminate the air. As a result, the contaminated air exhaled by the infected person contains any viruses or bacteria that would contaminate the environment. It might be inhaled by the people in the surroundings.

The invention looks like a respirator, but through novel design, it functions like a suction hood to remove all exhaled bioaerosols to protect the environment and people.

### SUMMARY OF THE INVENTION

A primary object of the present invention is to provide a respiratory extraction hood having a pre-storing passage, so that a distance between an air inlet and an air collection space is increased, and the user's high-pressure exhaled air initially flowing into the pre-storing passage is then sucked back into the collection space. Therefore, the high-pressure exhaled air will flow through a second opening to contact with a filter instead of flowing out of the respiratory extraction hood from the air inlet.

Another object of the present invention is to provide the above respiratory extraction hood, which has a first opening cross section area the same as the cross section area of the pre-storing passage, so that external air can flow continuously through the pre-storing passage into the first opening; and the flowing path of the external air is not influenced or changed by any difference in the area between the pre-storing passage cross section and the first opening cross section to thereby reduce the flow loss of the external air flowing into the respiratory extraction hood via the air inlet.

A further object of the present invention is to provide the above respiratory extraction hood, which has an outer cover that can be selectively replaced, allowing a user to assemble differently configured outer covers to an inner shell according to different situations, so as to change the distance of a path between the air inlet and the air collection space; and the shape and size of the pre-storing passage can be adjusted or expanded accordingly.

To achieve the above and other objects, the respiratory extraction hood of the present invention is configured to cover a user's mouth and nose, and includes a blocking member, an inner shell, an outer cover, a wearing member, a suction assembly, a filter, and a power supply. The blocking member includes a contacting section in contact with a user's face and a covering section extended forward from the contacting section, such that a collection space is defined on an inner side of the covering section; and the covering section is provided with a mounting opening. The inner shell is connected to the mounting opening and includes a first opening to be located above the user's nose and a second opening to be located below the user's nose, and both the first and the second opening are communicable with the collection space; and the inner shell has a male connection section provided on each of two lateral sides thereof.

In a first preferred embodiment, the outer cover includes an airflow guide section for shielding the first opening, and a female connection section formed at each of two lateral sides of the airflow guide section for detachably engaging with the male connection section at the same side. The airflow guide section is in contact with an outer side of the inner shell and the blocking member, such that a pre-storing passage is defined between the outer cover and the inner shell. The pre-storing passage has an end communicable with the collection space via the first opening and another end being an air inlet. The wearing member is connected to the respiratory extraction hood for holding the respiratory extraction hood in place on the user's head.

The flow guide section includes a first extension section, a second extension section, and a turning section located between the first and the second extension section. An amount of external air flowing through the turning section of the flow guide section is changed in flowing direction toward the first opening. The external air enters the air inlet and flows along a pre-storing path into the first opening. The pre-storing path has two opposite ends located at an air inlet profile of the air inlet and a first opening profile of the first opening, respectively, such that the external air can flow from any position on the air inlet profile along the pre-storing path to corresponding position on the first opening profile, and all paths defined in the above manners having the same path length in the pre-storing passage.

The first opening profile of the first opening is the same as a pre-storing passage profile of the pre-storing passage, such that the first opening has a first opening cross section, which has an area the same as that of a pre-storing passage cross section of the pre-storing passage.

The first extension section can be extended to be located closer to the second opening, such that the pre-storing passage cross section includes a blocked cross section being blocked by the second opening, and an exposed cross section not blocked by the second opening; and the exposed cross section has an area the same as that of the first opening cross section.

Each of the male connection sections on the inner shell includes a guide rail and a retaining member; and each of the female connection sections on the outer cover includes an abutting section. When the outer cover is perpendicularly assembled to the outer side of the inner shell, the abutting section is held in place between the guide rail and the retaining member.

The suction assembly includes a discharge pipe system assembled to the second opening and a fan assembled to the discharge pipe system. The filter is provided in the suction assembly. The power supply is electrically connected to the fan for driving the fan to rotate and produce an amount of suction airflow, which causes air in the collection space to flow toward the second opening to be discharged.

The pre-storing path defined between the air inlet and the first opening can change a distance between the user's nose and the air inlet. When the user produces an amount of high-pressure exhaled air, a part of the high-pressure exhaled air would flow initially into the pre-storing passage but then sucked by the suction airflow to flow continuously into the collection space. Accordingly, all the high-pressure exhaled air will flow through the second opening and the filter without flowing out of the respiratory extraction hood via the air inlet.

The second opening has a second opening cross section, an area of the second opening cross section is larger than that of the first opening cross section, such that a collection space cross section of the collection space gradually increases from the first opening toward the second opening, allowing the high-pressure exhaled air to stay in the collection space longer and have increased time of contacting with the suction airflow.

In a second preferred embodiment, the outer cover includes at least one flow guiding member to divide the pre-storing passage into a plurality of flow-guiding passages; and the external air flows through the plurality of flow guiding passages to enter the first opening.

Furthermore, a sponge can be disposed on an inner side of the outer cover for guiding flow, so that the external air flows through the sponge to enter the first opening.

The present invention is characterized in that the outer cover is detachably mounted to the inner shell to form the pre-storing passage between the inner shell and the outer cover; the blocking member includes the contacting section for correspondingly covering the user's face, and the covering section forward extended from the contacting section for the collection space to form on an inner side of the covering section; the inner shell is connected to the mounting opening on the covering section and includes the first opening located above the user's nose and the second opening located below the user's nose to communicate with the collection space; the first opening has a first opening profile, which is the same as the pre-storing passage profile of the pre-storing passage, so that the first opening cross section of the first opening has an area the same as that of the pre-storing passage cross section of the pre-storing passage; the outer cover includes a first flow guide section for shielding the first opening and a female connection section for removably engaging with the male connection section, such that the pre-storing passage is formed between the outer cover and the inner shell; the pre-storing passage has an end communicable with the collection space via the first opening and another end forming the air inlet, such that the distance of the path between the air inlet and the collection space is increased via the pre-storing passage; and the power supply is electrically connected to the fan to drive the fan to rotate and produce suction airflow, so that air in the collection space is sucked to flow toward and discharged from the second opening. When the user produces an amount of high-pressure exhaled air, a part of the high-pressure exhaled air flows initially into the pre-storing passage but is then sucked continuously by the suction airflow back to the collection space. Thus, all the high-pressure exhaled air will flow through the second opening and the filter provided thereat without flowing out of the respiratory extraction hood from the air inlet.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a respiratory extraction hood according to a first preferred embodiment of the present invention;

FIG. 2 shows the respiratory extraction hood of FIG. 1 put on a user's face for use;

FIG. 3 is an exploded perspective view of the respiratory extraction hood of FIG. 1;

FIG. 4A shows a blocking member and an inner shell for the respiratory extraction hood in the first preferred embodiment of the present invention;

FIG. 4B is a cutaway view showing the blocking member is assembled to the inner shell according to the first preferred embodiment of the present invention;

FIGS. 5A and 5B show an outer cover for the respiratory extraction hood in the first preferred embodiment of the present invention viewing from two different angles;

FIG. 6A is a top view showing a first opening cross section on the respiratory extraction hood of the first preferred embodiment of the present invention;

FIG. 6B is a cutaway view showing a pre-storing passage cross section on the respiratory extraction hood of the first preferred embodiment of the present invention;

FIG. 6C is a front view showing a second opening cross section on the respiratory extraction hood of the first preferred embodiment of the present invention;

FIG. 7 is a cutaway view showing the forming of suction airflow in the respiratory extraction hood according to the first preferred embodiment of the present invention;

FIG. 8 is a fragmentary, enlarged view of FIG. 7 showing the forming of suction airflow in the respiratory extraction hood according to the first preferred embodiment of the present invention;

FIG. 9 is a cross-sectional view of a respiratory extraction hood according to a second preferred embodiment of the present invention;

FIG. 10 is a phantom view showing airflows of external air that flow through flow-guiding passages of the respiratory extraction hood according to the second preferred embodiment of the present invention;

FIGS. 11 and 12 are assembled and exploded perspective views, respectively, showing a blocking member, an inner shell, an outer cover, and a wearing member for the respiratory extraction hood according to a third embodiment of the present invention;

FIG. 13 is an exploded perspective view showing the blocking member and the inner shell for the respiratory extraction hood according to the third embodiment of the present invention;

FIG. 14 is a cutaway view showing the blocking member is assembled to the inner shell according to the third embodiment of the present invention;

FIGS. 15 and 16 show the outer cover for the respiratory extraction hood in the third preferred embodiment of the present invention viewing from two different angles; and

FIG. 17 is a cutaway view showing a pre-storing passage cross section in the respiratory extraction hood according to the third embodiment of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

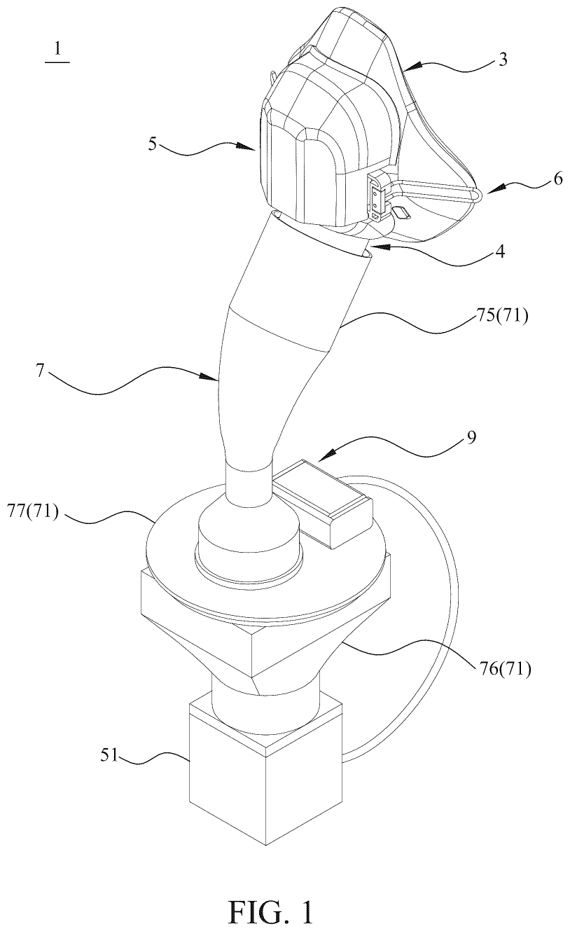

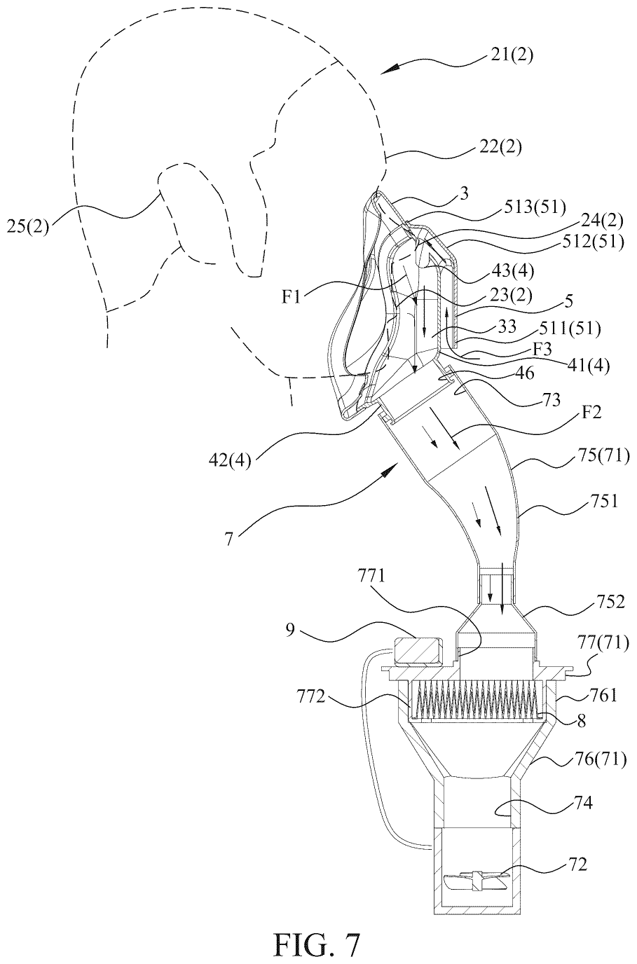

Please refer to FIGS. 1, 2, 3 and 7. A respiratory extraction hood 1 according to the present invention is designed for putting on a user's head 21 in front of his face 22, so as to shield the user's mouth 23 and nose 24 from external environment. When the user 2 breathes and sneezes via his nose 24 or speaks and coughs via his mouth 23, an amount of high-pressure exhaled air F1 is produced. The high-pressure exhaled air F1 is sucked into the respiratory extraction hood 1 to be filtered and purified before being discharged. These procedures advantageously suppress diseases that spread from one person to another through droplet infection, such as the flu, enterovirus infection, and coronavirus disease 2019 (COVID-19).

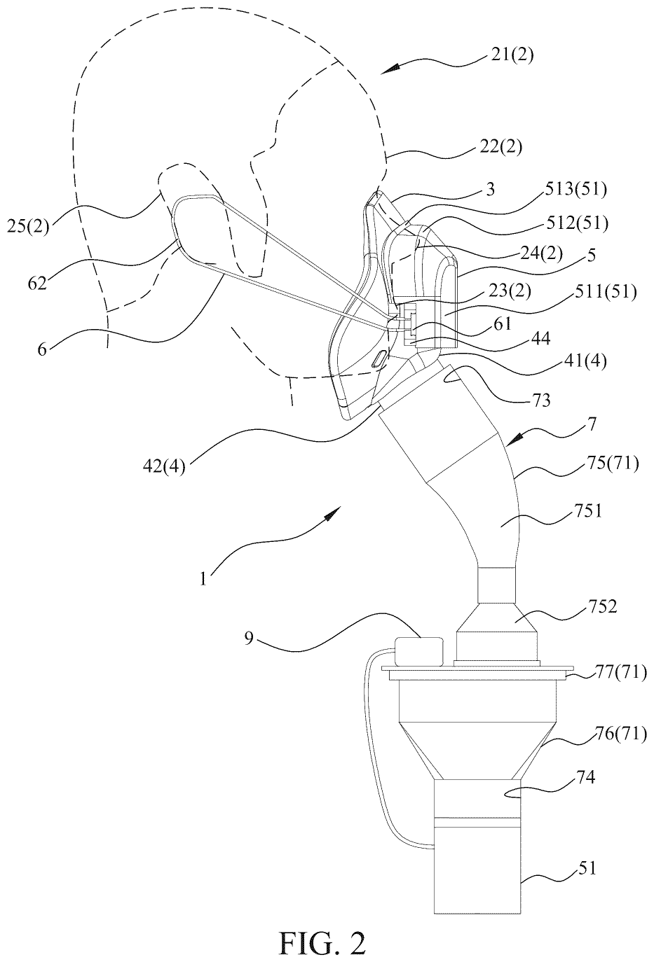

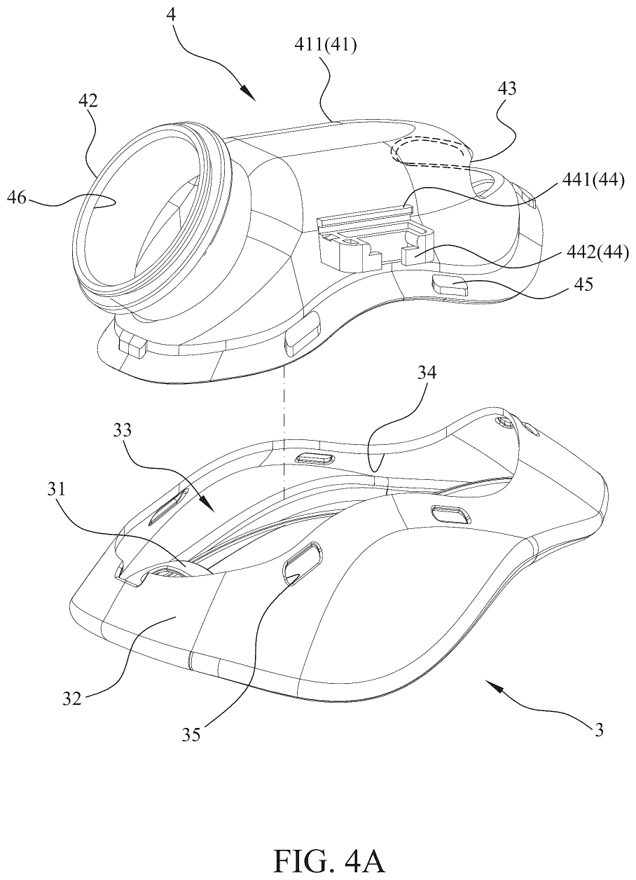

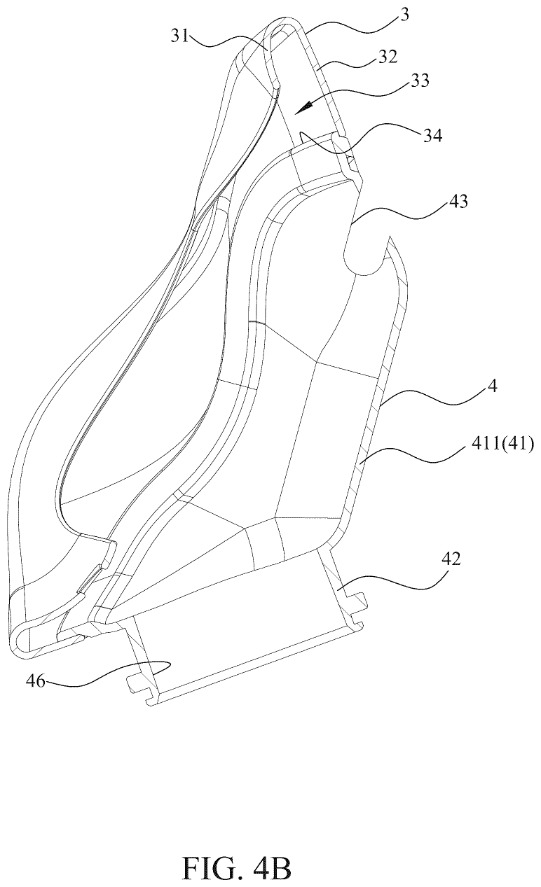

Please refer to FIGS. 2, 3, 4A, 4B, and 7. In a first preferred embodiment of the present invention, the respiratory extraction hood 1 includes a blocking member 3, an inner shell 4, an outer cover 5, a wearing member 6, a suction assembly 7, a filter 8, and a power supply 9. The blocking member 3 includes a contacting section 31 in contact with the user's face 22 and a covering section 32 extended forward from the contacting section 31 with a collection space 33 defined on an inner side of the covering section 32. The covering section 32 is provided with a mounting opening 34 and a plurality of through holes 35 located around an outer side of the mounting opening 34. The blocking member 3 can be made of any suitable material, such as a silicon gel or a latex material that is skin-friendly.

Please refer to FIGS. 2, 4A, 4B, 6B, and 6C. In the first preferred embodiment, the inner shell 4 is connected to the mounting opening 34 and includes an inner shell main body 41 and an exhalation pipe 42 extended from the inner shell main body 41. The inner shell main body 41 is so configured that it includes a first opening 43, male connection sections 44, and a plurality of protrusions 45. The first opening 43 is to be located above the user's nose 24, and the male connection sections 44 are located at two lateral outer sides of the inner shell 4. The male connection section 44 each includes a guide rail 441 and a retaining member 442, both being provided on an outer side of the inner shell main body 41. The protrusions 45 are spaced along an outer periphery of the inner shell main body 41. In the first preferred embodiment, when the respiratory extraction hood 1 is put on the user's head 21, the first opening 43 should be located in front of the user's nose 24, and the first opening 43 is oriented to the outer cover 5 to define a first opening profile 431. In the first preferred embodiment, the first opening profile 431 is a curved profile. The exhalation pipe 42 includes a second opening 46 to be located below the user's nose 24. In the first preferred embodiment, the second opening 46 is located in the vicinity of the user's mouth 23; both the first opening 43 and the second opening 46 are communicable with the collection space 33; and both the guide rail 441 and the retaining member 442 are provided between the first opening 43 and the second opening 46. Further, the inner shell main body 41 includes a curved outer wall 411 located between the first opening 43 and the second opening 46. The protrusions 45 on the inner shell 4 are extended through the through holes 35 on the blocking member 3 to be retained to the blocking member 3, such that the blocking member 3 is connected to the outer periphery of the inner shell 4. When the inner shell 4 is held to the user's head 21, the blocking member 3 is compressed to fit on the user's face 22.

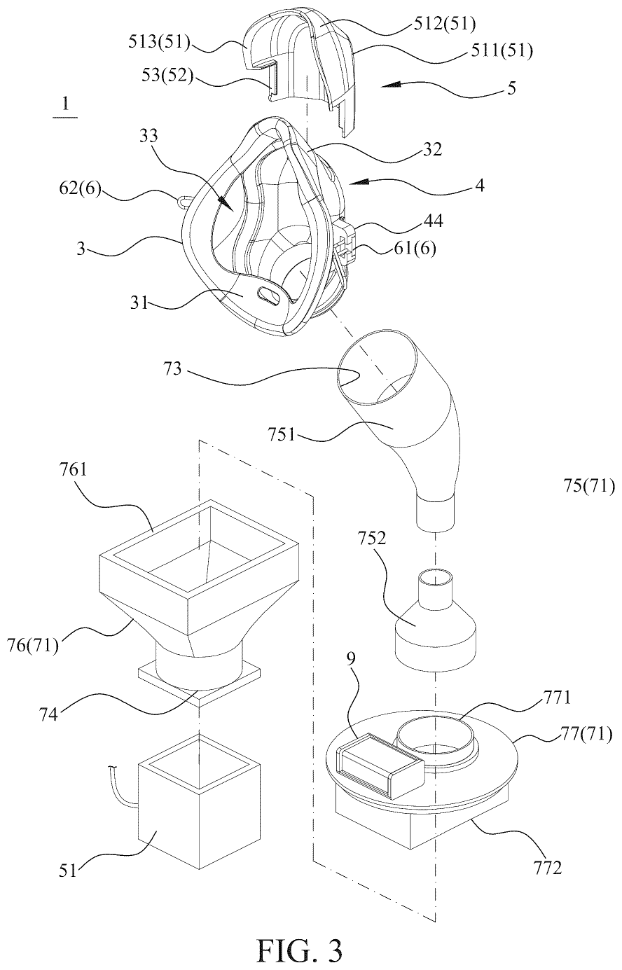

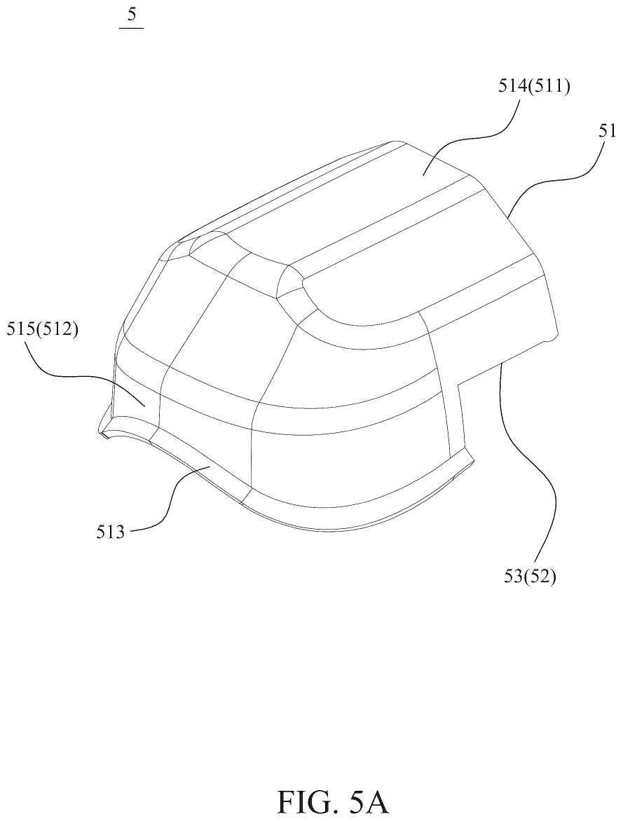

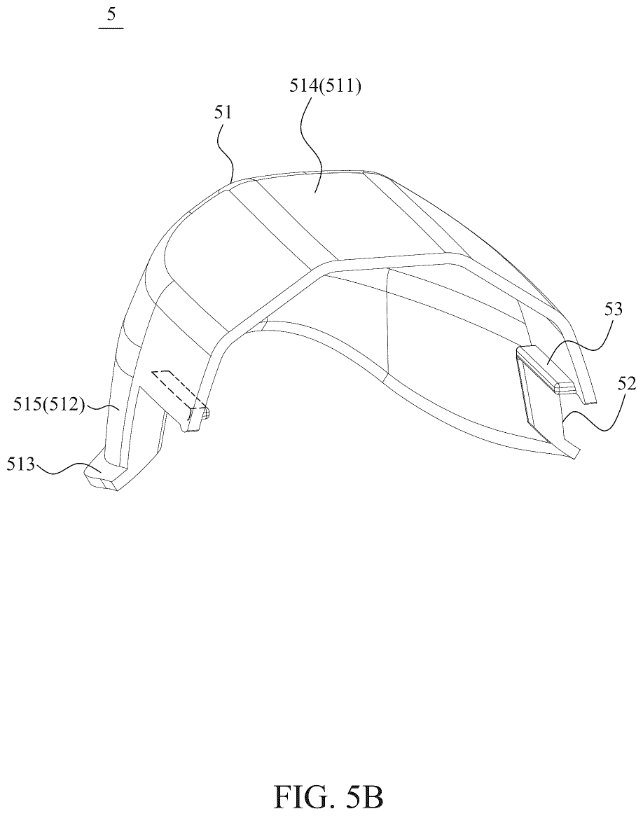

Please refer to FIGS. 3, 4A, 4B, 5A, 5B, 6A, and 6B. In the first preferred embodiment, the outer cover 5 includes an airflow guide section 51 and female connection sections 52 formed on the airflow guide section 51. The airflow guide section 51 includes a first extension section 511, a second extension section 513, and a turning section 512 located between the first and the second extension section 511, 513; and is configured for covering the first opening 43. In the first preferred embodiment, the first extension section 511 is formed of a polygonal outer wall 514 and the turning section 512 is formed of a polygonal outer wall 515. The female connection sections 52 are provided on an outer periphery of the outer cover 5 and respectively include an abutting section 53 for connecting to the first extension section 511 and the turning section 512. The abutting section 53 on the outer cover 5 can be moved toward the retaining member 442 of the inner shell 4, such that the outer cover 5 can be perpendicularly assembled to an outer side of the inner shell 4. At this point, the abutting section 53 is abutted on and retained to between the guide rail 441 and the retaining member 442, and the airflow guide section 51 is in contact with the outer side of the inner shell 4 and the blocking member 3 while the second extension section 513 is fitly attached to an outer wall of the inner shell 4, enabling the outer cover 5 to closely and tightly engage with the inner shell 4. With the above arrangements, a pre-storing passage 54 is formed between the outer cover 5 and the inner shell 4. The pre-storing passage 54 has an end communicating with the collection space 33 via the first opening 43, and another end forming an air inlet 55. That is, in the respiratory extraction hood 1 of the present invention, the female connection sections 52 are removably assembled to the male connection sections 44, so that the outer cover 5 can be removably assembled to the outer side of the inner shell 4. Wherein the volume of the pre-storing passage 54 is over than 200 cc.

Please refer to FIGS. 1, 2, 3, 4A, and 6C. In the first preferred embodiment, each of the wearing member 6 includes an engaging section 61 and an elastic section 62 connected to the engaging section 61. The engaging sections 61 are respectively engaged with a recess 47 formed on the retaining member 442, such that the wearing member 6 are connected to the male connection sections 44 of the inner shell 4 and located at two lateral sides of the outer cover 5. The elastic section 62 is an elastic strap encloses an independent circular space to be fitly put around the user's ear 25. The wearing member 6 is not limited to any particular structural configuration, the wearing member 6 can be straps made of an elastically extendable material for directly tying to the male connection sections 44 on the inner shell 4.

Please refer to FIGS. 1, 2, 3, and 7. In the first preferred embodiment, the suction assembly 7 includes a discharge pipe system 71 and a fan 72. The discharge pipe system 71 is assembled to the second opening 46 of the inner shell 4, and the fan 72 is assembled to a distal end of the discharge pipe system 71. The discharge pipe system 71 has opposite proximal and distal ends, which are an inlet 73 and an outlet 74, respectively; and further includes a first adapter 75 forming the inlet 73, a second adapter 76 forming the outlet 74, and a hollow mounting base 77 located between the first adapter 75 and the second adapter 76. The first adapter 75 includes a first pipe segment 751 connected to the second opening 46 and an expanded pipe segment 752 connected to the first pipe segment 751, and the first pipe segment 751 is tapered from the second opening 46 toward the expanded pipe segment 752. The hollow mounting base 77 has a top and a bottom provided with a round wall portion 771 and a rectangular wall portion 772, respectively. The round wall portion 771 is located adjacent to the expanded pipe segment 752 of the first adapter 75 and defines a first flow passage cross section; the rectangular wall portion 772 is located adjacent to the second adapter 76 and defines a second flow passage cross section, which is larger than the first flow passage cross section. The second adapter 76 is connected to the rectangular wall portion 772 at an upper adapter end 761 and to the fan 72 at the outlet 74. A downward tapered wall portion is formed between the adapter end 761 and the outlet 74, so that the second flow passage cross section of the rectangular wall portion 772 is larger than an outlet cross section of the second adapter 76. The filter 8 is filled in the hollow mounting base 77 of the suction assembly 7 and includes a plurality of creases to provide an increased filtration area.

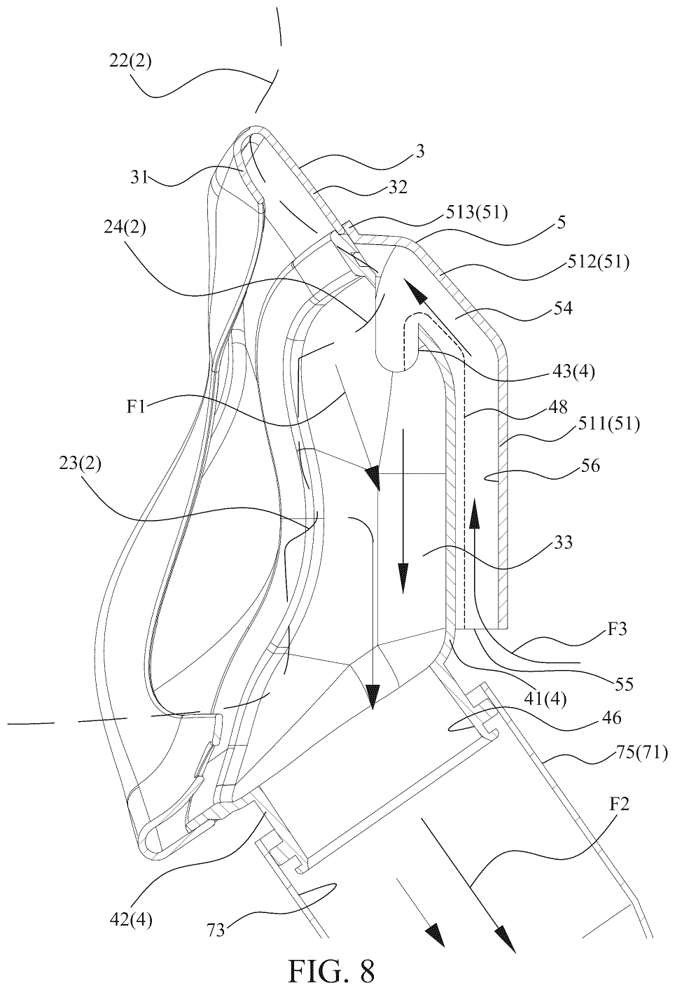

Please refer to FIGS. 2, 3, 7 and 8. In the first preferred embodiment, the power supply 9 is electrically connected to the fan 72 of the suction assembly 7, so that the fan 72 rotates continuously to produce a suction airflow F2 in the collection space 33 on the inner side the blocking member 3. Due to the fan 72, a pressure difference is formed in the inner shell 4, allowing an amount of external air F3 to enter into the outer cover 5 via the air inlet 55 and flows through the first extension section 511 and the turning section 512 of the outer cover 5 sequentially. When the external air F3 passes through the turning section 512, it changes its flow direction in the airflow guide section 51 to pass through the pre-storing passage 54 to the inner side of the inner shell 4 via the first opening 43, allowing the external air F3 to enter the pre-storing passage 54 continuously for use by the user 2 and to enter the first opening 43 continuously. With these arrangements, a pre-storing path 48 is formed between the air inlet 55 and the first opening 43. The pre-storing path 48 changes a distance between the user's nose 24 and the air inlet 55 and allows the external air F3 to stay in the respiratory extraction hood 1 longer. On the other hand, when the user 2 takes breaths, sneezes, speaks, or coughs to produce the high-press exhaled air F1, a part of the high-pressure exhaled air F1 would initially enter the pre-storing passage 54 but is then sucked continuously by the suction airflow F2 into the collection space 33. In this manner, all the high-pressure exhaled air F1 and the air in the collection space 33 are collected in the inner shell 4 to flow along with external air F3 toward the second opening 46 into the suction assembly 7, and be discharged from another side of the fan 72 finally. Since the filter 8 is distributed on an airflow path of the suction airflow F2, all the external air F3 and the high-pressure exhaled air F1 will pass the filter 8 to ensure that the discharged gas does not contain any virus and the high-pressure exhaled air F1 does not flow out of the respiratory extraction hood 1 via the air inlet 55. The high-pressure exhaled air F1 passed the filter 8 and discharged from the respiratory extraction hood 1 mixes with the external air F3, and the mixture of the high-pressure exhaled air F1 and the external air F3 can flow through the pre-storing passage 54 into the first opening 43.

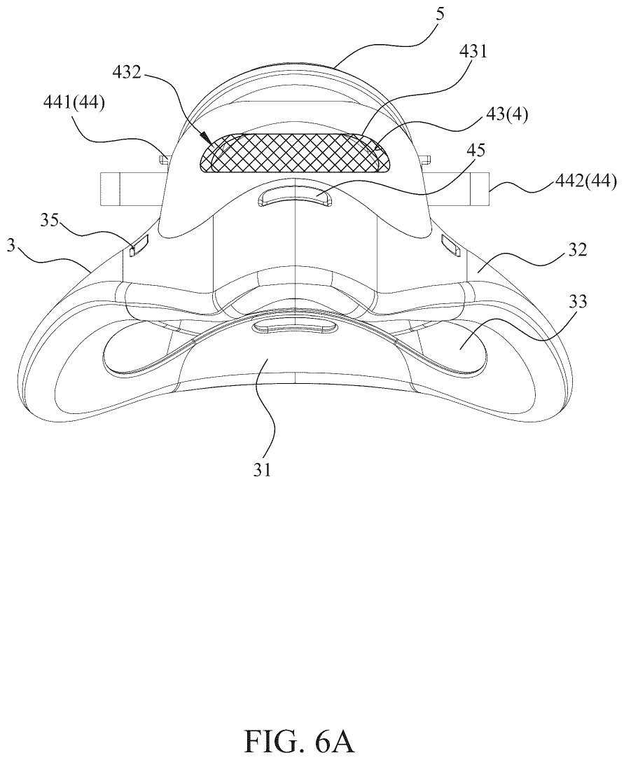

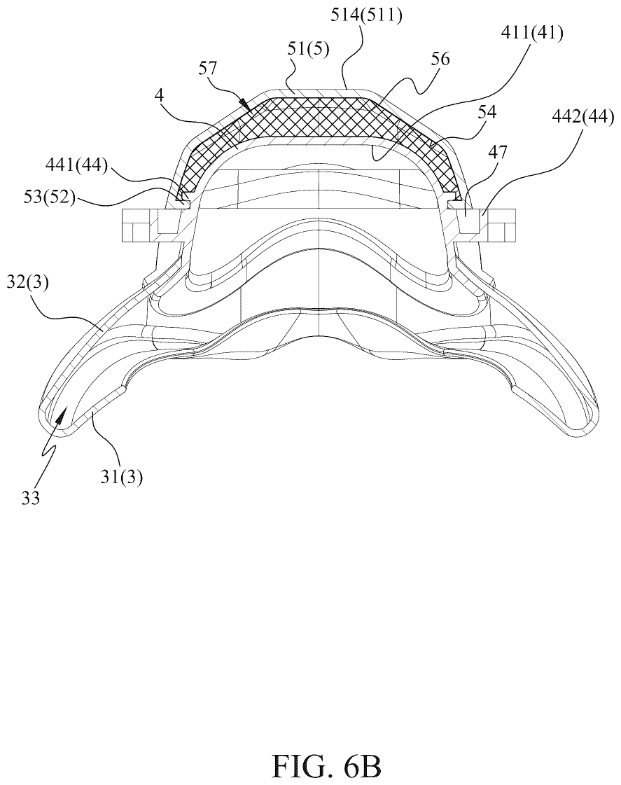

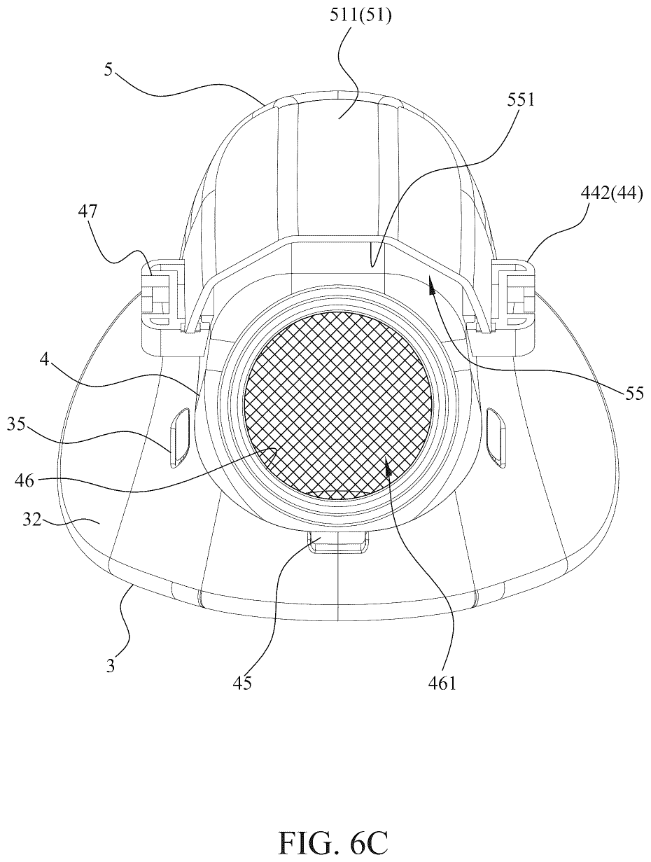

Please refer to FIGS. 6A to 6C, 7, and 8. In the first preferred embodiment, the first opening profile 431 of the first opening 43 is the same as a pre-storing passage profile 56 of the pre-storing passage 54. The pre-storing passage profile 56 is defined between the outer wall 411 of the inner shell main body 41 and the outer wall 514 of the first extension section 511, and between the outer wall 411 of the inner shell main body 41 and the outer wall 515 of the turning section 512, such that the first opening cross section 432 of the first opening 43 has an area the same as that of a pre-storing passage cross section 57 of the pre-storing passage 54. Thus, when the external air F3 flows from the air inlet 55 through the pre-storing passage 54 along the pre-storing path 48 into the first opening 43, two opposite ends of the above described path are communicable with an air inlet profile 551 of the air inlet 55 and the first opening profile 431 of the first opening 43, and the external air F3 can flow from any position on the air inlet profile 551 along the pre-storing path 48 to any position on the first opening profile 431. Further, all paths defined in the above manners have the same path length in the pre-storing passage 54, so that the external air F3 can flow continuously without changing its path with changes in the area of the pre-storing passage cross section 57 or the first opening cross section 432 to thereby reduce the flow loss of the external air F3. It is noted the first extension section 511 of the outer cover 5 is not limited to any specific configuration. The first extension section 511 may be extended toward the air inlet 55 to be located closer to the second opening 46, such that the pro-storing passage cross section 57 of the pre-storing passage 54 includes a blocked cross section being blocked by the second opening 46 and an exposed cross section not blocked by the second opening 46 and located at two lateral sides of the second opening 46. It is noted the exposed cross section has the same cross section area as that of the first opening cross section 432.

The second opening 46 has a second opening cross section 461 larger than the first opening cross section 432 of the first opening 43, such that the collection space 33 has a collection space cross section gradually increased from the first opening 43 toward the second opening 46. With this configuration, the high-pressure exhaled air F1 can stay in the collection space 33 longer to have increased of time of contacting with the suction airflow F2.

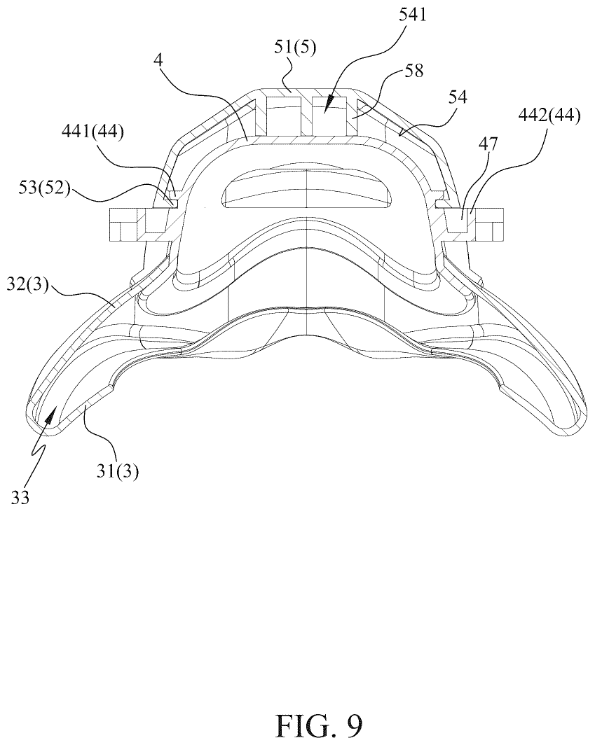

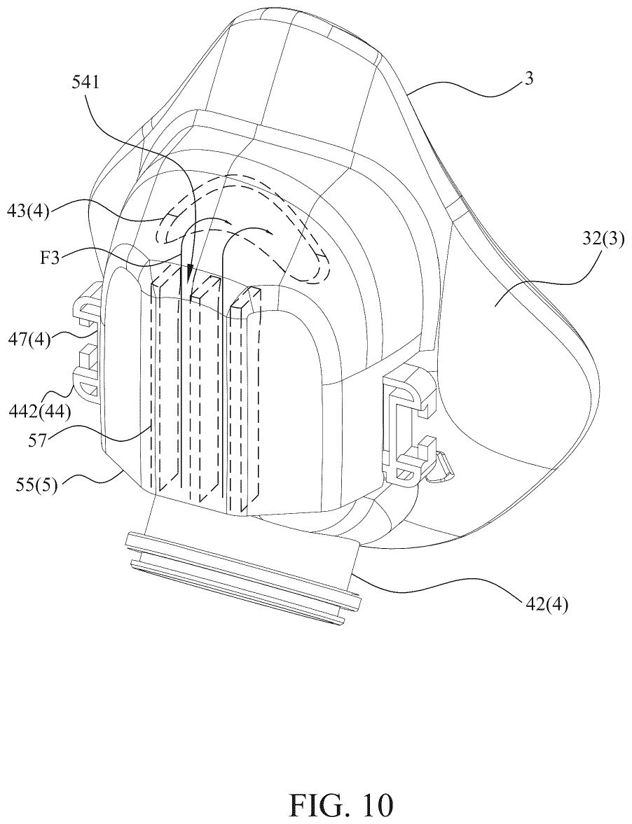

Please refer to FIGS. 9 and 10, in which a second preferred embodiment of the present invention is shown. The second preferred embodiment is different from the first one in the configuration of the outer cover 5. Since the blocking member 3, the inner shell 4, the wearing member 6, the suction assembly 7, the filter 8, and the power supply 9 all are similar to those in the first preferred embodiment, they are not described repeatedly herein. As shown, the outer cover 5 in the second preferred embodiment further includes at least one flow guiding member 58 provided inside the outer cover 5. The flow guiding member 58 is formed of a plate located in parallel with the guide rail 441. In the illustrated second preferred embodiment, there are three flow guiding members 58, which divide the pre-storing passage 54 into a plurality of flow-guiding passages 541. The external air F3 flowing through the plurality of flow-guiding passages 541 is regulated or oriented and then flows into the first opening 43. In this manner, the external air F3 can flow continuously through a central zone and outer zones located at two lateral sides of the central zone in the pre-storing passage 54 while maintaining the same airflow's strength. There is not any particular limitation to the configuration of the flow guiding member 58, which can be a piece of sponge disposed on an inner side the outer cover 5, and the external air F3 flows through the sponge before entering the first opening 43.

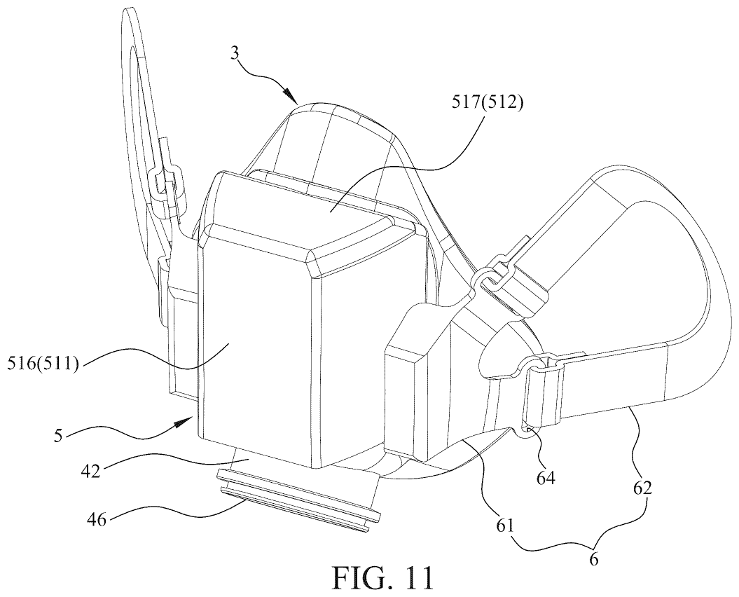

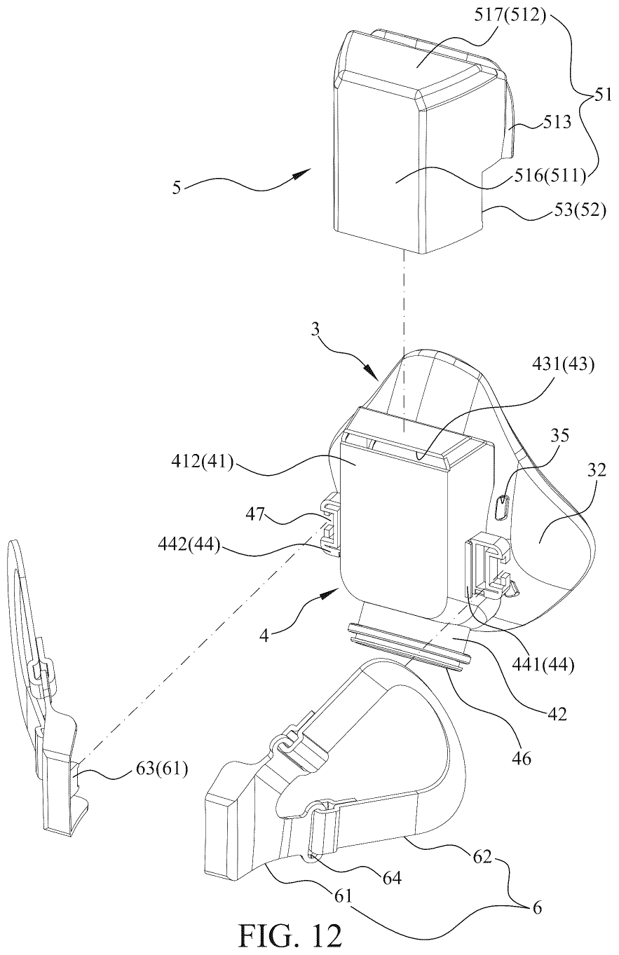

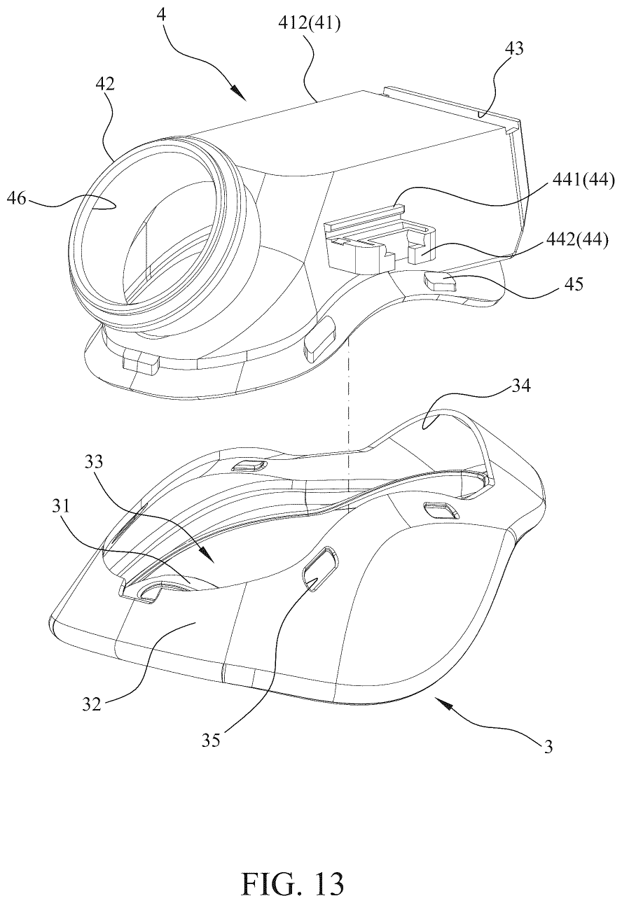

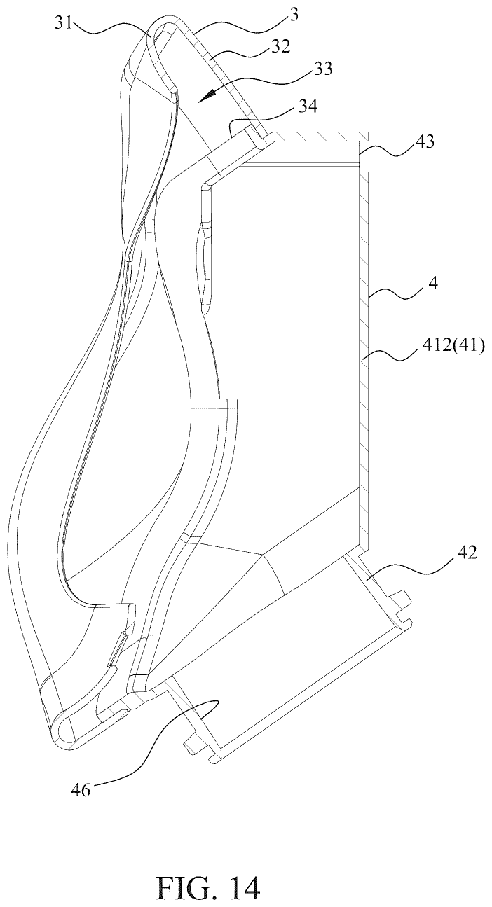

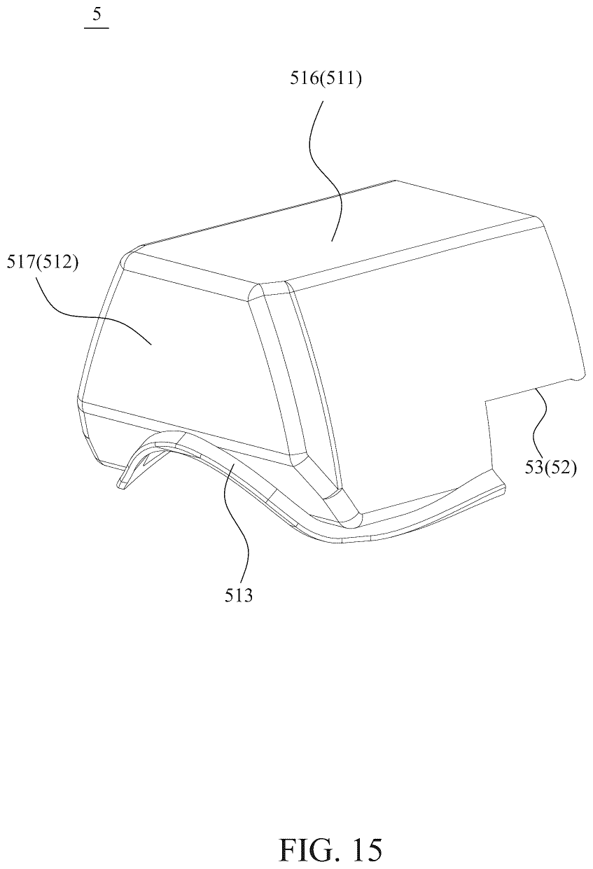

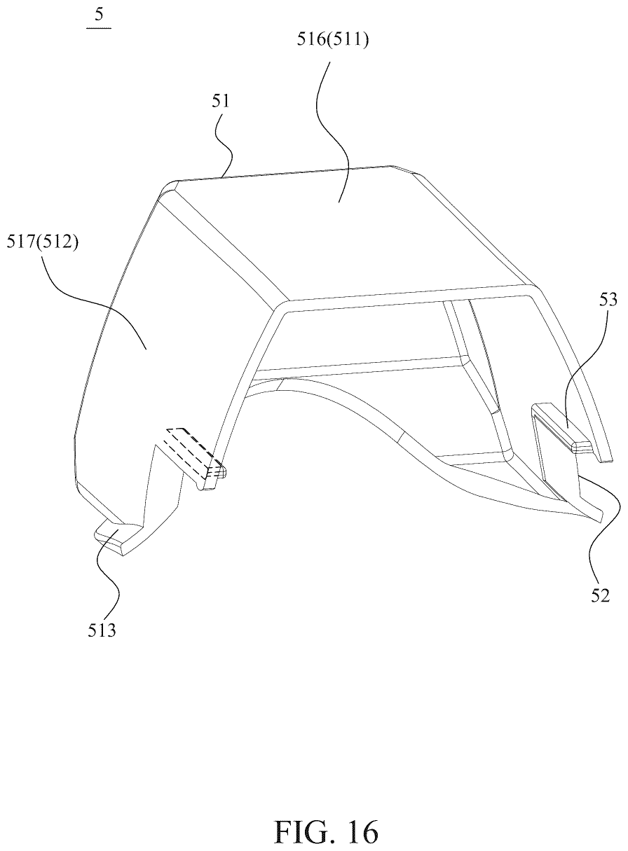

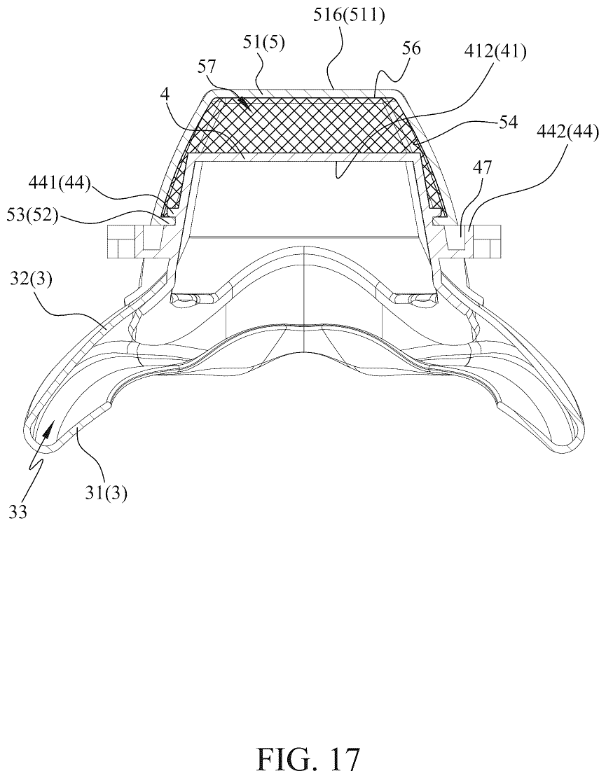

Please refer to FIGS. 11 to 17, in which a third preferred embodiment of the present invention is shown. In the third preferred embodiment, the inner shell 4 and the outer cover 5 are structurally similar to those in the first preferred embodiment but have different appearances, and the wearing member 6 are different from those in the first preferred embodiment in both appearance and structure. As to the blocking member 3, the suction assembly 7, the filter 8, and the power supply 9, they are identical to those in the first preferred embodiment in both appearance and structure, and are therefore, not repeatedly described herein. As shown, in the third preferred embodiment, the first opening 43 of the inner shell 4 has an elongated first opening profile 431, and the inner shell main body 41 of the inner shell 4 includes a flat and straight outer wall 412 extended between the first opening 43 and the second opening 46; and the first extension section 511 of the outer cover 5 includes a flat straight outer wall 516 and the turning section 512 of the outer cover 5 also includes a flat straight outer wall 517. In the third preferred embodiment, the pre-storing passage profile 56 is defined between the outer wall 412 of the inner shell main body 41 and the outer wall 516 of the first extension section 511, and between the outer wall 412 of the inner shell 41 and the outer wall 517 of the turning section 512; the first opening profile 431 of the first opening 43 is the same as the pre-storing passage profile 56 of the pre-storing passage 54; and the first opening cross section 432 of the first opening 43 has an area the same as that of the pre-storing passage cross section 57 of the pre-storing passage 54.

Please refer to FIGS. 11 to 17. In the third preferred embodiment, the wearing member 6 includes an engaging section 61 and an elastic section 62 connected to the engaging section 61. The engaging section 61 includes a hook portion 63 and a plurality of holes 64. When the hook portion 63 is hooked to the recess 47 of the retaining member 442, the engaging section 61 is engaged with the retaining member 442 to be located at a lateral side of the outer cover 5. The elastic section 62 has two opposite ends, which are extended through the plurality of holes 64 and accordingly connected to the engaging section 61, such that the wearing member 6 can be connected to the male connection sections 44 on the inner shell 4.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A respiratory extraction hood for covering a wearer's mouth and nose, comprising:
a blocking member including a contact section in contact with a user's face and a covering section extended forward from the contacting section, such that a collection space is defined on an inner side of the covering section; and the covering section being provided with a mounting opening;
an inner shell being connected to the mounting opening and including a first opening to be located above the user's nose and a second opening to be located below the user's nose, and both the first opening and the second opening being communicable with the collection space; and two lateral sides of the inner shell having a male connection section;
an outer cover including an airflow guide section for shielding the first opening, and a female connection section formed at each of two lateral sides of the airflow guide section for detachably engaging with the male connection section at the same side on the respiratory extraction hood; the airflow guide section being in contact with an outer side of the inner shell and the blocking member, such that a pre-storing passage is defined between the outer cover and the inner shell; and the pre-storing passage having an end communicable with the collection space via the first opening and another end being an air inlet;
a wearing member being connected to the respiratory extraction hood for holding the respiratory extraction hood in place on the user's head;
a suction assembly including a discharge pipe system assembled to the second opening and a fan assembled to the discharge pipe system;
a filter being provided in the suction assembly; and
a power supply being electrically connected to the fan for driving the fan to rotate and produce an amount of suction airflow, which causes air in the collection space to flow toward the second opening to be discharged; and
wherein a pre-storing path is formed between the air inlet and the first opening to change a distance between the user's nose and the air inlet; when the user produces an amount of high-pressure exhaled air, a part of the high-pressure exhaled air flows initially into the pre-storing passage but is then sucked by the suction airflow to flow continuously into the collection space; and accordingly, all the high-pressure exhaled air will flow through the second opening and the filter without flowing out of the respiratory extraction hood via the air inlet.

2. The respiratory extraction hood as claimed in claim 1, wherein the first opening defines a first opening profile, and the first opening profile is the same as a pre-storing passage profile of the pre-storing passage, such that the first opening has a first opening cross section, and the first opening cross section has an area the same as that of a pre-storing passage cross section of the pre-storing passage.

3. The respiratory extraction hood as claimed in claim 2, wherein the flow guide section includes a first extension section, a second extension section, and a turning section located between the first extension section and the second extension section; and an amount of external air flowing through the turning section of the flow guide section changing its flowing direction toward the first opening.

4. The respiratory extraction hood as claimed in claim 3, wherein the external air flows from the air inlet along the pre-storing path into the first opening; the pre-storing path having two opposite ends located at an air inlet profile of the air inlet and the first opening profile of the first opening, respectively, such that the external air can flow from any position on the air inlet profile along the pre-storing path to corresponding position on the first opening profile, and all paths defined in the above manners having the same path length in the pre-storing passage.

5. The respiratory extraction hood as claimed in claim 3, wherein the first extension section can be extended to be located closer to the second opening, such that the pre-storing passage cross section includes a blocked cross section being blocked by the second opening, and an exposed cross section not blocked by the second opening; and the exposed cross section having an area the same as that of the first opening cross section.

6. The respiratory extraction hood as claimed in claim 1, wherein each of the male connection sections on the inner shell includes a guide rail and a retaining member; and each of the female connection sections on the outer cover includes an abutting section; whereby when the outer cover is perpendicularly assembled to the outer side of the inner shell, the abutting section is held in place between the guide rail and the retaining member.

7. The respiratory extraction hood as claimed in claim 2, wherein the second opening has a second opening cross section, an area of the second opening cross section is larger than that of the first opening cross section, such that a collection space cross section of the collection space gradually increases from the first opening toward the second opening, allowing the high-pressure exhaled air to stay in the collection space longer and have increased time of contacting with the suction airflow.

8. The respiratory extraction hood as claimed in claim 3, wherein the outer cover includes at least one flow guiding member to divide the pre-storing passage into a plurality of flow-guiding passages; and the external air flows through the plurality of flow guiding passages to enter the first opening.

9. The respiratory extraction hood as claimed in claim 3, wherein a sponge is disposed on an inner side of the outer cover for guiding flow, so that the external air flowing through the sponge to enter the first opening.
